(19) United States
(12) Patent Application Publication
(10) Pub. No.: US 2016/0185533 A1
(43) Pub. Date: Jun. 30, 2016

(54) OPERATING A SORTING SYSTEM FOR ITEMS HAVING VARIATING SIZE

(71) Applicant: CRISPLANT A/S, Aarhus N (DK)

(72) Inventors: Uffe LYKKEGAARD, Aarhus C (DK); Jørgen STAUN, Hinnerup (DK)

(21) Appl. No.: 14/909,435

(22) PCT Filed: Aug. 7, 2014
(86) PCT No.: PCT/DK2014/050237

§ 371 Date: Feb. 1, 2016

(30) Foreign Application Priority Data
Aug. 8, 2013 (DK) PA 2013 70435

(51) Int. Cl. B65G 47/52; B07C 1/02; B65G 47/96

(52) U.S. Cl. CPC B65G 47/52; B65G 47/96; B07C 1/02

(57) ABSTRACT

The present invention relates to a method of operating a sorting system for receiving items of variating sizes at one or more loading locations and off-loading items at one or more off-loading locations, where the sorting system comprises a plurality of carts, said carts having at least one support area, which may be operated to load and off-load items, respectively, or where on board or non- on board means may be used to cause loading and off-loading of one or more items, and where the loading and off-loading of items may be done both to starboard and port sides of a transport direction of the carts. More specifically, the present invention relates to a method of operating a sorting system, where items to be sorted are pre-arranged and pre-oriented upstream in a conveying path, and diverted and loaded onto the carts, while maintaining the pre-arrangement and pre-orientation.

### TECHNICAL FIELD

The present invention relates to a method of operating a sorting system for receiving items at one or more loading locations and off-loading items at one or more off-loading locations, where the sorting system comprises a plurality of carts, said carts having at least one support area, which may be operated to load and off-load items, or where onboard or non-onboard means may be used to cause loading and off-loading of items, and where the loading and off-loading of items may be done both to starboard and port sides of a transport direction of the carts. More specifically, the present invention relates to a method of operating a sorting system, where items to be sorted are pre-arranged and pre-oriented upstream in a conveying path, and diverted and loaded onto the carts, while maintaining the pre-arrangement and pre-orientation.

### BACKGROUND

It is generally sought, when designing sorter systems, to keep a low complexity, to keep track of items to be sorted and to load the items onto the carts under controlled circumstances. This means e.g. that mis-oriented and/or mis-arranged items are to be avoided, as this may cause misplacement of the items on the carts, which again may mean lost items, items which cannot be off-loaded precisely etc. Moreover, it is also sought to use the carts support areas, i.e. the areas which may carry one or more items, to a highest possible degree, which e.g comprises to be able to carry more than one small item on a single cart and oversize items on at least two consecutive carts.

Different options have been suggested to handle this.

EP 0 963 929 discloses a way of re-arranging the sequence of items, in order to place the items on a cross-belt sorter, so that starboard side and portside items are correctly loaded and located on the cart for off-loading. Also items size-wise suited for a single cart may be loaded. A, in a horizontal plane, turnable conveyor 8 is used for this. However, the conveyor takes up space and when two items are turned for switching place in the sequence, all transport belts need to stop during the turning, which is time consuming and may lead to empty carts passing the loading station.

EP 0 700 844 discloses how items, which are too large to fit a cart, may be loaded onto two consecutive carts. However, a complex control system is required for operating the belts on the carts in relation to the sorter speed in order to precisely orient the item on the carts.

Hence, an improved sorter system would be advantageous, and in particular a more efficient and/or reliable method of operating the sorter system would be advantageous.

It is one object of the present invention to provide an improvement to the earlier presented art. Other objectives may be derived from the specification and figures.

### SUMMARY

The present invention comprises a method of operating a sorting system for receiving items at one or more loading locations and off-loading items at one or more off-loading locations, where the sorting system comprises a plurality of carts, said carts having at least one support area, which may be operated to load and off-load items, respectively, or where onboard or non-onboard means may be used to cause loading and off-loading of items, and where the loading and off-loading of items may be done both to starboard and port sides of a transport direction of the carts, the method comprising
pre-arranging items to be sorted as well as pre-orienting the items, in a way such that the items are arranged and oriented to fit one or more support areas,
forwarding the pre-arranged and pre-oriented items downstream toward the carts of the sorting system,
before loading the items onto the carts, receiving the pre-arranged and pre-oriented items at a diverter according to size:
   one or more items being smaller than a support area, and fitting to at least part of the size of one support area, and
   medium items having a size, where only one item may be arranged to fit to the size of one support area, and
   one or more large items having a size, where one item is larger than the size of a single support area, and being adapted to fit at least two consecutive support areas,
and after receiving the pre-arranged and pre-oriented items at the diverter, diverting the items at an angle sideways to an induction conveyor, while maintaining the pre-arrangement and the pre-orientation of the items as received by the diverter,
and further while maintaining the pre-arrangement and the pre-orientation of the items, loading the items with the induction conveyor onto the carts support areas, which are to receive and be loaded with one or more predetermined approaching items, and dependent on item size,
   a. inducting one or more small pre-arranged and pre-oriented items until said one or more small items are received by a cart support area, and
   b. inducting a pre-arranged and pre-oriented medium item until said medium item is received by a cart support area, and
   c. inducting one or more large pre-arranged and pre-oriented items until said large items are received by at least two consecutive cart support areas.

The following short explanation of the technical effect of the invention is to be construed as in no way limiting the scope of the claims, but merely as constructive information. In order to avoid the aforementioned issues with the already known earlier art, the present invention suggests in short to pre-arrange and pre-orient the items upstream to the loading of the items onto the support areas of the carts. This removes time consuming operations at zones of loading the items and may be done manually or by a combination of scanning, turning and moving equipment in order to prepare the items for downstream being loaded onto the support areas in a controlled and predetermined sequence. When the items are pre-arranged and pre-oriented upstream, the diverter may maintain this configuration of the items, when diverting the items to an induction conveyor, where the induction conveyor keeps maintaining said configuration until the items are received by the support areas. In this way, the items are loaded precisely in a controlled, predetermined order, whereby the items may be safely transported by the carts to one or more off-loading positions, where they may be precisely off-loaded in a controlled manner. Also, the method is suited for handling both small, medium and large size items with one sorting system.

The items to be sorted may be pre-arranged as well as pre-oriented, in a way such that the items are arranged to fit to a support area, which comprise that before the items are transferred to the diverter, that one or more small items are arranged and being oriented in such a manner, that a total length and width in a horizontal plane of said one or more small items fit to a length and width of a support area. This enables a high degree of utilizing the space of the supporting areas.

The pre-arranging of one or more small items to be sorted as well as pre-orienting the items, in a way such that the one or more small items are arranged to fit a support area, may comprise that before the items are transferred to the diverter, that the small items are oriented in such a manner, that said small items also are co-aligned with an orientation and arrangement, that fit to a longitudinal centerline of the support area, which is predetermined to receive said small items. The co-alignment of the small items with the longitudinal centerline of the support area ensures a well suited placement of the items on the support area, both for loading, transport and off-loading.

A longitudinal centerline of a support area may be transverse or parallel to a moving direction of said support area. Whether the longitudinal centerline is transverse or parallel to the moving direction depends on the design of the support area, which again may be dependent on the type and size of the items to be sorted by the sorting system.

The pre-arranging of medium and large items as well as pre-orienting the items, in a way such that the items are arranged to fit to at least one support area, comprise that before the items are transferred to the diverter, that medium and large items are arranged and oriented in such a manner, that a total length and width in a horizontal plane of medium and large items fit to a length and width of at least one support area. This enables a high degree of utilizing the space of the supporting areas.

The prearranging of medium and large items to be sorted as well as pre-orienting the items, in a way such that the medium and large items are arranged to fit to at least one support area, may comprise that before the items are transferred to the diverter, that said medium and large items oriented in such a manner, that said medium and large items are each also co-aligned with an orientation, that provides most distance from all sides of the at least one support area, which is predetermined to receive said medium and large items. The co-alignment of the medium and large items, such as to fit in order to provide most distance from all sides of the at least one support area, ensures a well suited placement of the items on the support area, both for loading, transport and off-loading by providing a centering of the items in relation to the support area or areas.

The at least one induction conveyor is located adjacent to the diverter, where the induction conveyor receives pre-arranged and pre-oriented items, and conveys the items to the carts at an angle sideways and onto the carts corresponding to a sideways angle as received from the diverter. This ensures that the items stay pre-arranged and pre-oriented from the diverter to the induction conveyor and onto the carts. Also, this ensures a well suited placement of the items on the support area, both for loading, transport and off-loading.

The conveying of the items with the induction conveyor is at a predetermined acceleration and speed and at an angle sideways and onto the carts, where the predetermined acceleration and speed of the induction conveyor is adapted to the speed of the carts, in order that the conveyed items are to be received by predetermined support areas. This ensures, that the pre-arrangement and the pre-orientation of the items maintained on the induction conveyor, also are maintained, when the items are received by the support areas. A non-adapted acceleration and speed of the induction conveyor would result in a slip or slide between the items and the support areas and thereby an imprecise loading of the items, which as aforementioned may result in lost items and imprecise off-loading.

The diverted items, that are diverted at an angle sideways to reach the support areas, where said angle sideways is different from and less than orthogonal relative to a transport direction of support areas, which are to receive one or more predetermined approaching items from the diverter. The angle sideways provides a transport direction vector component of the items parallel to the transport direction of the support areas, which eases the loading and receipt of the items on the support areas, as the time frame for the loading and receipt increases as the angle decreases. Hence, an acute angle sideways will be preferred.

The pre-arranging of items to be sorted as well as pre-orienting the items, in a way such that the items are arranged to fit one or more support areas, may include that a distance between the items is adapted, such that one or more predetermined support areas may receive one or more predetermined items. The distance between the items may vary on a downstream conveying route towards the carts due to varying conveying speed, but the distance should be adapted, when the items are received by the induction conveyor, such that small, medium and large item may be loaded onto predetermined support areas in a synchronized manner. A distance between the items may also be desired, when two items are loaded onto one or more support areas, and are to be off-loaded to different sides in relation to the moving direction of the support areas.

While pre-arranged and pre-oriented items are being conveyed towards and onto the support areas, this may be performed such that transitions from one conveyor to another, or to support areas, are done at substantially same vertical level. Any such transitions or shifts in the vertical conveying level, whether it is upward jumps or downward falls may result in loss of the pre-arrangement and pre-orientation of the items, which will cause imprecise loading and off-loading of the items. However, during conveying, except from the transitions, the conveying may change the vertical level of the items.

### BRIEF DESCRIPTION OF THE FIGURES

The method according to the invention will now be described in more detail with regard to the accompanying figures. The figures show one way of implementing the present invention and is not to be construed as being limiting to other possible embodiments falling within the scope of the claims.

The FIGS. 1-6, and 14, are schematic top views of various conveying and loading situations. FIGS. 7 to 13 are schematic views of details of components of the sorting system.

FIGS. 1-6 show a sorting system, where the support areas are shorter in a transport direction of the support areas, than a width in the transverse direction. FIG. 14 shows a sorting system, where the support areas are longer in a transport direction of the support areas, than a width in the transverse direction.

FIGS. 1a-1f show a sequence of situations from receiving two small items until the loading of the items onto a support area,

FIGS. 2a - 2d show a sequence of situations from receiving medium item until the loading of the item onto a support area,

FIG. 3 shows a number of twin sets of large items being diverted and loaded onto two support areas,

FIG. 4 shows loading of a large item onto two support areas,

FIG. 5 shows loading of a large item onto three support areas,

FIG. 6 shows loading of a sequence of items having varying size,

FIG. 7a shows two large items oriented in such a manner, that they are also co-aligned with an orientation, that fit to provide most distance from all sides of the at least one support area.

FIG. 7b shows co-alignment of a medium item on a longitudinal centerline of surface area.

FIGS. 8a and 8b show a front view of a tilt tray-type cart,

FIG. 9 shows a front view of a cross-belt-type cart,

FIG. 10 shows a front view of a roller-type cart,

FIG. 11 shows a front view of a fixed tray-type cart,

FIG. 12 shows a front view of a spherical ball-type cart,

FIG. 13a shows a top view of a diverter with two sets of wheels, where each wheel set have different directions,

FIG. 13b shows a top view of a diverter with driven spherical balls, where the balls are adapted to convey items in at least two directions.

FIG. 14 shows loading of a sequence of items having varying size, where the support areas are longer in a transport direction of the support areas, than a width in the transverse direction.

### DETAILED DESCRIPTION

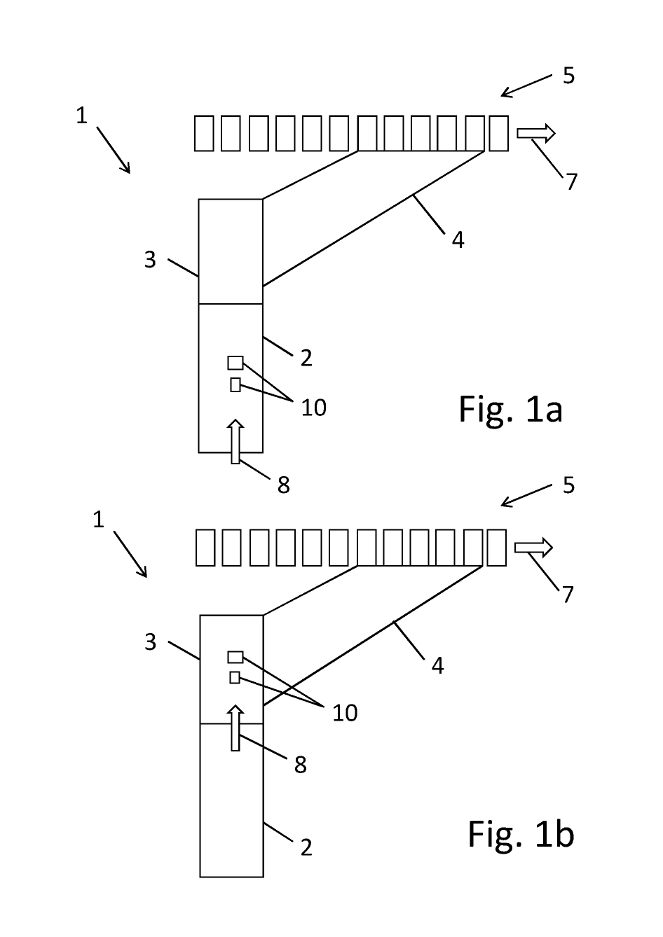

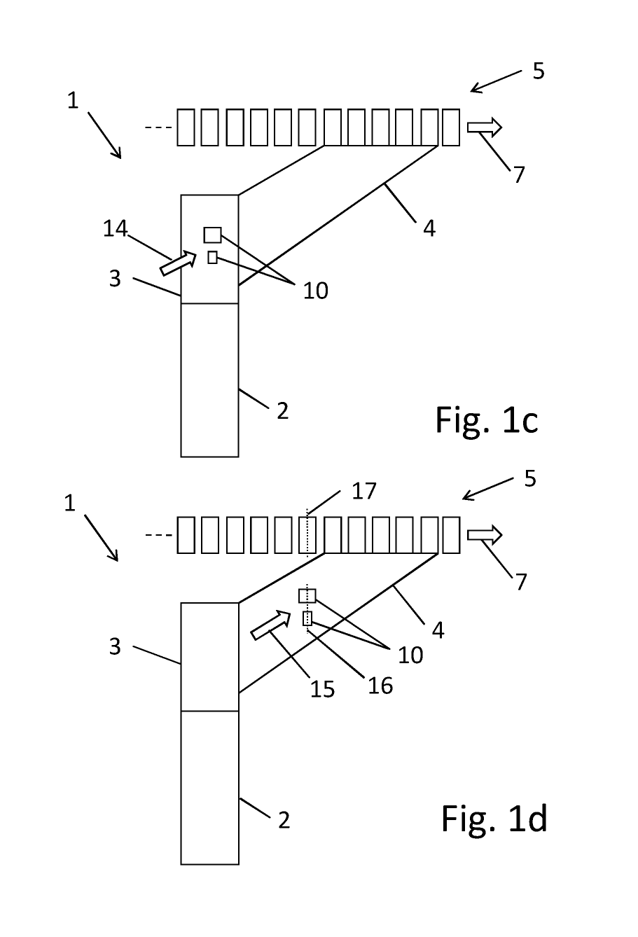

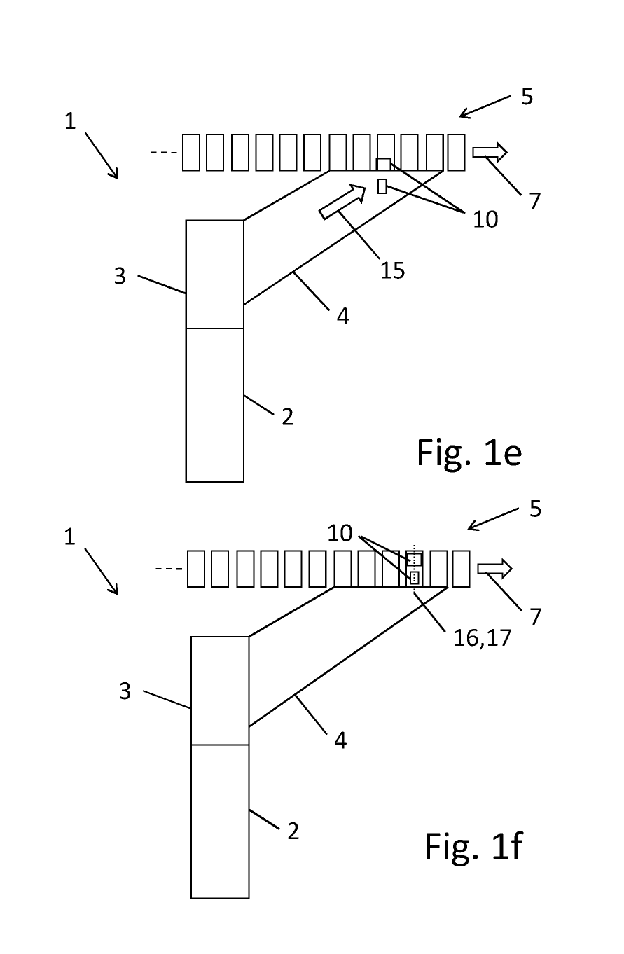

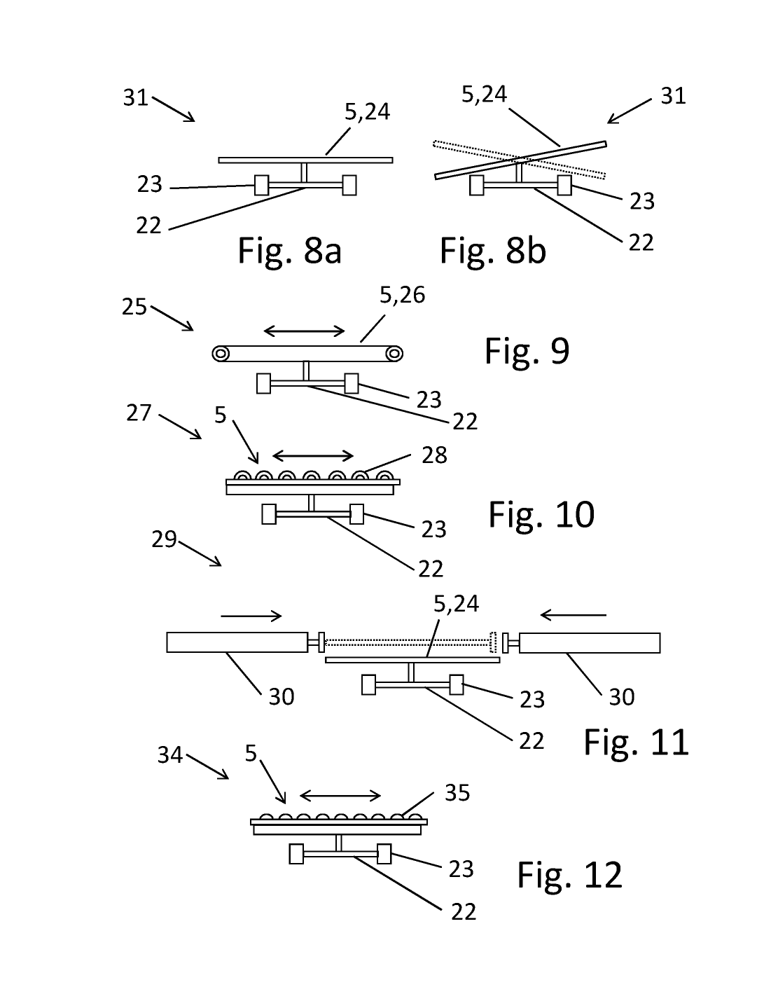

FIGS. 1a-1f show a sorter system 1 comprising a conveying system 2. The conveying system 2 is shown with only one conveyor, but may include any number of conveyors of any type suitable for conveying small items 10, medium items 11 and large items 12 downstream to a diverter 3. The sorting system 1 is adapted for receiving items at one or more loading locations and off-loading items at one or more off-loading locations (not shown). The sorting system comprises a plurality of carts, which are not shown in FIGS. 1a-1f. Carts may be seen on FIGS. 8-12. Instead is shown a number of support areas 5, which may belong to any number of carts. Hence, a cart may comprise one or more support areas 5. The transport direction of the support areas is indicated by the arrow 7. Adjacent to the diverter 3 is located an induction conveyor 4, which loads the items onto the support areas 5. The not shown carts are usually coupled together to form a train-like configuration, which may form an endless loop.

In FIG. 1a is shown how two small items 10, which have been pre-arranged as well as pre-oriented, in a way such that the items 10 are arranged and oriented to fit a support area 5. The pre-arrangement and the pre-orientation have been performed e.g. manually or by suitable mechanical equipment before being received by the diverter 3. A direction of movement of the items 10 is indicated by the arrow 8.

In FIG. 1b it is shown how the items 10 are conveyed to the diverter 3, without changing the pre-arrangement and pre-orientation. At the diverter 3 the items 10 may have a short stop.

In FIG. 1c it is shown how the items 10 now are diverted under an angle indicated by the arrow 14, while maintaining the pre-arrangement and pre-orientation of the items.

In FIG. 1d it is shown how the items 10 are forwarded by the induction conveyor 4 under an angle sideways and towards the support areas 5. The angle is indicated by the arrow 15. Also shown, as an option, is that the two items 10 are pre-arranged and pre-oriented as well as co-aligned, indicated by a dotted line 16, in order to fit to a longitudinal centerline of a support area 5, as indicated by the dotted line 17.

In FIGS. 1e and 1f it is shown how the items 10 keep progressing towards and onto support areas 5, until they are fully received. And as shown in FIG. 1f, that co-aligned items 10 have a centerline 16, which fits with a longitudinal centerline 17 of a support area 5, as indicated by the coinciding dotted lines 16 and 17. This is preferred, but a mere pre-arrangement and pre-orientation suited for making the items fit to a support area may do.

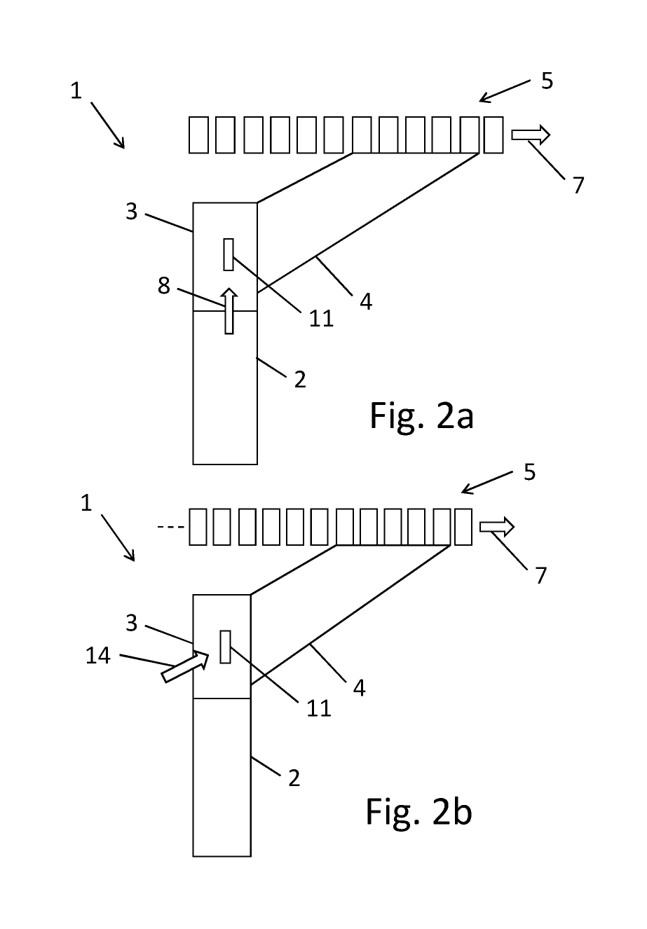

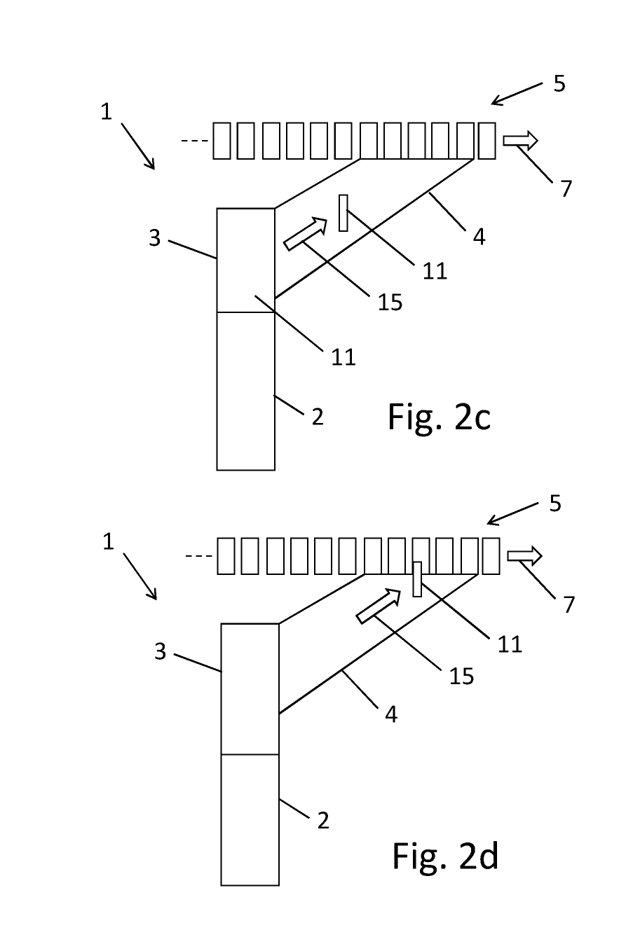

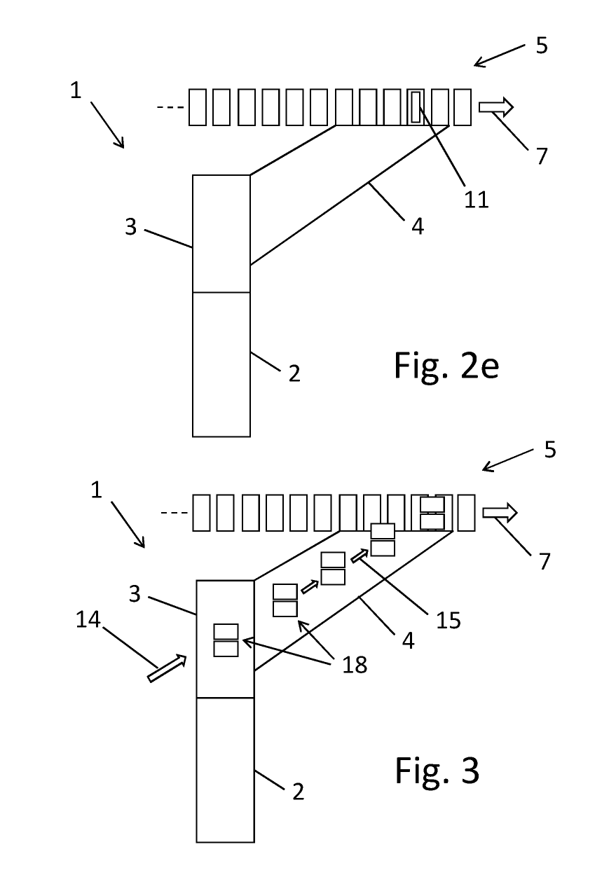

FIGS. 2a- 2e show a sorter system 1 comprising a conveying system 2. The conveying system 2 is shown with only one conveyor but may include any number of conveyors of any type suitable for conveying items downstream to a diverter 3. The sorting system 1 is adapted for receiving items at one or more loading locations and off-loading items at one or more off-loading locations (not shown). The sorting system comprises a plurality of carts, which are not shown in FIGS. 2a-2e. Carts may be seen on FIGS. 8-12. Instead is shown a number of support areas 5, which may belong to a number of carts. The transport direction of the support areas is indicated by the arrow 7. Adjacent to the diverter 3 is located an induction conveyor 4, which loads the items onto the support areas 5. FIGS. 2a-2e show in principle a similar course of loading items onto a support area 5 as FIGS. 1a-1f. The only difference is that here it is medium items 11.

FIG. 3 shows a sorter system 1 comprising a conveying system 2. The conveying system 2 conveys items downstream to a diverter 3. The sorting system 1 is adapted for receiving items at one or more loading locations and off-loading items at one or more off-loading locations (not shown). The sorting system comprises a plurality of carts, which are not shown in FIG. 3. The transport direction of the support areas is indicated by the arrow 7. Adjacent to the diverter 3 is located an induction conveyor 4, which loads the items onto the support areas 5. FIG. 3 shows in principle a similar course of loading items 18 onto a support area 5 as FIGS. 1a-1f and 2a-2e. However, in FIG. 3 the items 18 are twin sets of medium items, but the same principle would apply to longer large items, being loaded onto two or more support areas 5.

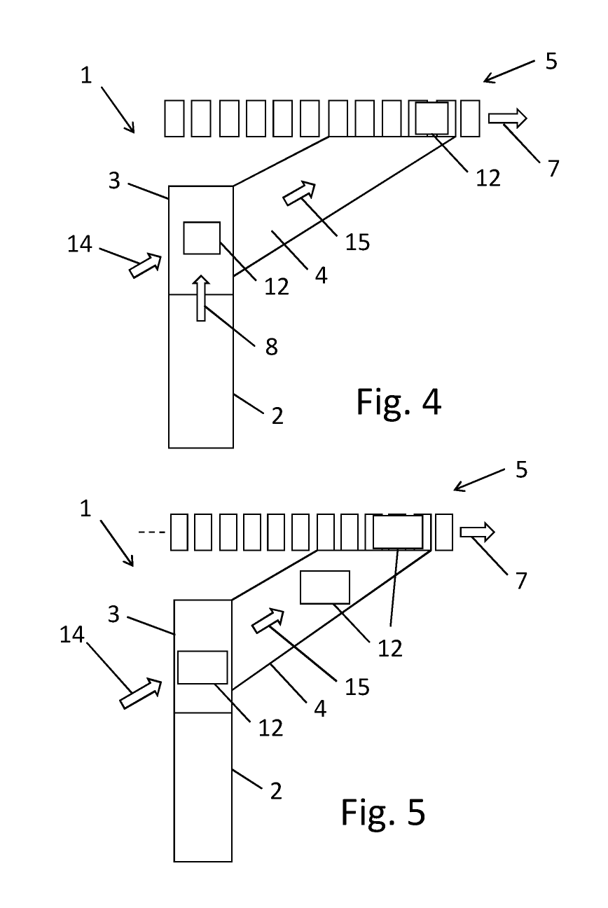

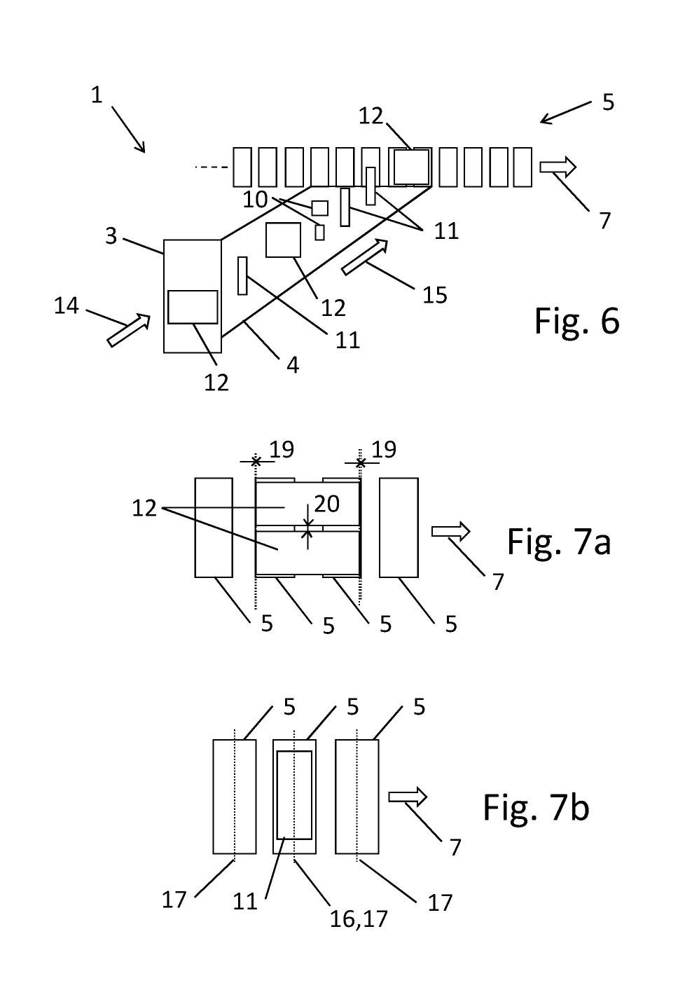

FIG. 4 shows a sorter system 1 similar to those of FIGS. 1a-1f, 2a-2e and 3. In this case the loaded items 12 are large items, which have a size that requires minimum two consecutive support areas for being loaded onto. The same applies to FIG. 5, where large items 12 are loaded onto three support areas 5. FIG. 6 shows how the sorting may take place during operation of the sorter system 1, where items 10, 11, 12 of varying size are continuously loaded onto support areas 5.

It is to be noted that in all of FIGS. 1a-1f, 2a-2e and 3-6, that the pre-arrangement of the items as well as the pre-orientation of the items from being received at the diverter 3 and until being loaded onto one or more support areas are maintained throughout.

FIG. 7a shows four support areas 5, where two items 12 are loaded onto two support areas 5. A transport direction is indicated by the arrow 7. To ensure safe loading, conveying and off-loading the items are placed with an equal distance 19 to back and forward ends in the transport direction of the support areas 5, and preferably to all sides of the transport areas. Also, a distance 20 between the items 12 is present in order to separate the items 12 for being off-loaded, or discharged, at off-loading location on a starboard and a port side, respectively. In case both items 12 are off-loaded to a same side, a distance 20 may not be necessary.

FIG. 7b shows three support areas 5, where each has a longitudinal centerline 17. And where a medium item 11 has also a longitudinal centerline 16, such that the item 11 is placed as centered as possible, again to ensure safe loading, conveying and off-loading the items. A transport direction is indicated by the arrow 7.

FIGS. 8a and 8b show a tilt tray-type cart 21 having a tray 24 with a support area 5, frame 22 and wheels 23 adapted to fit to a not shown track. FIG. 8b shows the tilting of the tray 24 and support area 5. With dotted lines is shown a tilt to an opposite side.

FIG. 9 shows a cross-belt-type cart 25 having a cross-belt 26 with a support area 5, frame 22 and wheels 23 adapted to fit to a not shown track. As the arrow shows, the belt may be run to the right hand side as well as a left hand side. This is used when loading and off-loading items from the support area 5.

FIG. 10 shows a driven roller type cart 27 having driven rollers 28 with a support area 5, frame 22 and wheels 23 adapted to fit to a not shown track. As the arrow shows, the rollers may be run to the right hand side as well as a left hand side. This is used when loading and off-loading items from the support area 5.

FIG. 11 shows a fixed tray type cart having a tray 24 with a support area 5, frame 22 and wheels 23 adapted to fit to a not shown track. To off-load items from the support area, external means are used. Here, it is indicated that pneumatic cylinders 30 are used. However, any suitable kind of external pusher, drawer or guiding means may be used. The dotted lines indicate the left hand cylinder in its fully extended situation. An onboard device, not shown, may also be used, such as a pusher, drawer or any other actuator.

FIG. 12 shows a driven spherical ball type cart 34 having driven balls 35 with a support area 5, frame 22 and wheels 23 adapted to fit to a not shown track. As the arrow shows, the balls may be driven to the right hand side as well as a left hand side. This is used when loading and off-loading items from the support area 5.

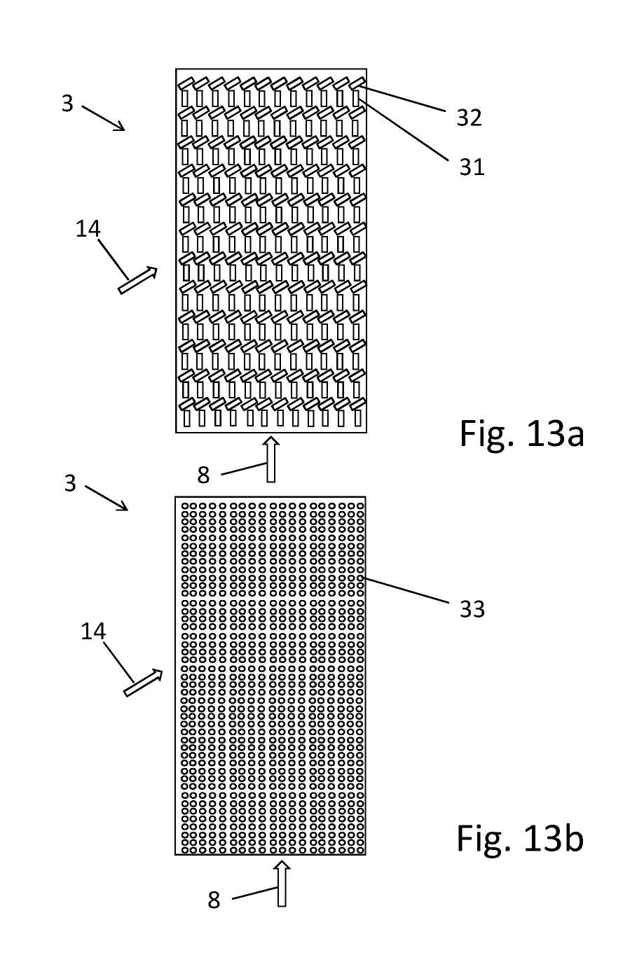

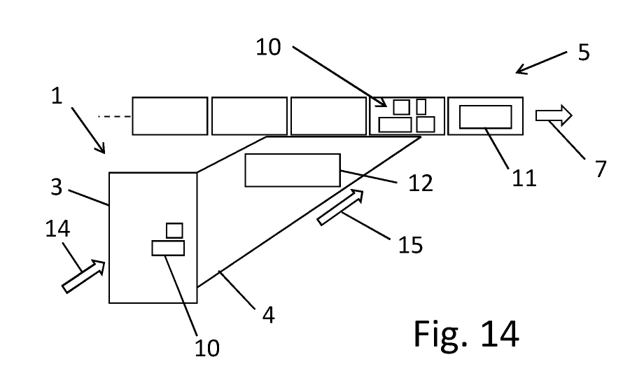

FIGS. 13a and 13b show variants of a diverter 3. In FIG. 13a a plurality of wheels 31 are adapted to receive items from a not shown conveyor. The items are received in the direction indicated by the arrow 8. Another plurality of wheels 32 may be raised slightly, or the wheels 31 lowered slightly, when an item may be stopped in order to be diverted using the wheels 32 and diverting the item at an angle indicated by the arrow 14. In FIG. 13b the diverter is fitted with driven spherical balls 33 instead of wheels 31, 32. Items may be received from a conveyor at an angle indicated by the arrow 8 and diverted at an angle indicated by the arrow 14. Both variants 13a and 13b may be controlled to divert one or more items received from a conveyor and onto an induction conveyor nonstop for enhanced capacity.

Not shown in the figs., the following may apply to the induction conveyor 4. The induction conveyor 4 may comprise driven cylindrical rollers for supporting and conveying the items to the support areas. In another variant a plurality of parallel driven belts or straps may be used for supporting and conveying the items to the support areas.

Although the present invention has been described in connection with the specified variants, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method of operating a sorting system for receiving items at one or more loading locations and off-loading items at one or more off-loading locations, where the sorting system comprises a plurality of carts, said carts having at least one support area, which may be operated to load and off-load items, or where onboard or non-onboard means may be used to cause loading and off-loading of items, and where the loading and off-loading of items may be done both to starboard and port sides of a transport direction of the carts, the method comprising
pre-arranging items to be sorted as well as pre-orienting the items, in a way such that the items are arranged and oriented to fit one or more support areas,
forwarding the pre-arranged and pre-oriented items downstream toward the carts of the sorting system,
before loading the items onto the carts, receiving the pre-arranged and pre-oriented items at a diverter according to size:
two or more items being smaller than a support area, and fitting to at least part of the size of one support area, and
medium items having a size, where only one item may be arranged to fit to the size of one support area, and
one or more large items having a size, where one item is larger than the size of a single support area, and being adapted to fit at least two consecutive support areas,
and after receiving the pre-arranged and pre-oriented items at the diverter, diverting the items at an angle sideways to an induction conveyor, while maintaining the pre-arrangement and the pre-orientation of the items as received by the diverter,
and further while maintaining the pre-arrangement and the pre-orientation of the items, loading the items with the induction conveyor onto the one or more support areas, which are to receive and be loaded with one or more predetermined approaching items, and dependent on item size,
a. inducting two or more small pre-arranged and pre-oriented items until said two or more small items are received by one support area, and
b. inducting a pre-arranged and pre-oriented medium item until said medium item is received by one support area, and
c. inducting one or more large pre-arranged and pre-oriented items until said large items are received by at least two consecutive support areas.

2-17. (canceled)

18. The method according to claim 1, wherein pre-arranging items to be sorted as well as pre-orienting the items, in a way such that the items are arranged to fit to one or more support areas, comprise that before the items are transferred to the diverter, that two or more small items are arranged and oriented in such a manner, that a total length and width in a horizontal plane of said two or more small items fit to a length and width of one support area.

19. The method according to claim 1, wherein pre-arranging two or more small items to be sorted as well as pre-orienting the items, in a way such that the two or more small items are arranged to fit one support area, comprise that before the items are transferred to the diverter, that the small items are oriented in such a manner, that said small items also are co-aligned with an arrangement and orientation, that fit to a longitudinal centerline of the support area, which is predetermined to receive said small items.

20. The method according to claim 1, wherein pre-arranging medium and large items as well as pre-orienting the items, in a way such that the items are arranged to fit to at least one support area, comprise that before the items are transferred to the diverter, that medium and large items are arranged and oriented in such a manner, that a total length and width in a horizontal plane of medium and large items fit to a length and width of at least one support area.

21. The method according to claim 1, wherein prearranging medium and large items to be sorted as well as pre-orienting the items, in a way such that the medium and large items are arranged to fit to at least one support area, comprise that before the items are transferred to the diverter, that said medium and large items are oriented in such a manner, that said medium and large items are also co-aligned with an orientation, that provides most distance from all sides of the at least one support area, which is predetermined to receive said medium and large items.

22. The method according to claim 1, wherein at least one induction conveyor is located adjacent to the diverter, where the induction conveyor receives pre-arranged and pre-oriented items, and conveys the items to the support areas at an angle sideways and onto the support areas corresponding to a an angle sideways as received from the diverter.

23. The method according to claim 1, wherein the conveying of the items with the induction conveyor is at a predetermined acceleration and speed and at an angle sideways and onto the support areas, where the predetermined acceleration and speed of the induction conveyor is adapted to the speed of the support areas, in order that the conveyed items are to be received by predetermined support areas.

24. The method according to claim 1, wherein the diverted items, which are diverted at an angle sideways to reach the support areas, that said angle sideways is different from and less than orthogonal relative to a transport direction of support carts, which are to receive one or more predetermined approaching items from the diverter.

25. The method according to claim 1, wherein pre-arranging items to be sorted as well as pre-orienting the items, in a way such that the items are arranged to fit one or more support areas, include that a distance between the items are adapted, such that one or more predetermined support areas may receive one or more predetermined items.

26. The method according to claim 1, wherein the pre-arranged and pre-oriented items, while being conveyed towards and onto the support areas, that transition from one conveyor to another, or to a support area, are performed at substantially same vertical level.

27. The method according to claim 1, wherein a majority of the carts of the sorting system is of a cross-belt type cart.

28. The method according to claim 27, wherein the cross-belt type cart comprise at least two cross-belts.

29. The method according to claim 1, wherein a majority of the carts are of a cylindrical roller type and which is adapted to move items in one or more predetermined directions for loading and off-loading items.

30. The method according to claim 1, wherein a majority of the carts of the sorting system is of a tilt-tray type cart.

31. The method according to claim 30, wherein a majority of the carts of the sorting system is of a tilt-tray type cart, where at least one item is arranged on a tote, which tote is to be arranged on the tilt-tray.

32. The method according to claim 1, wherein a majority of the carts are of a driven spherical ball type and which is adapted to move items for loading and off-loading items.

33. The method according to claim 1, wherein a majority of the carts of the sorting system is of a type, where the support area is a fixed surface, and where items are offloaded with onboard or non-onboard means selected from a group comprising mechanical pushers and drawers, pneumatic pushers and drawers, electrical pushers and drawers, any kind of actuator, as well as on-off operable guide.
